(19) United States
(12) Patent Application Publication
(10) Pub. No.: US 2012/0311326 A1
(43) Pub. Date: Dec. 6, 2012

(54) APPARATUS AND METHOD FOR PROVIDING PERSONAL INFORMATION SHARING SERVICE USING SIGNED CALLBACK URL MESSAGE

(75) Inventors: Seung Hyun KIM, Daegu-city (KR); Dae Seon CHOI, Daejeon-city (KR); Jong Hyouk NOH, Daejeon-city (KR); Sang Rae CHO, Daejeon-city (KR); Yeong Sub CHO, Daejeon-city (KR); Seung Hun JIN, Daejeon-city (KR)

(73) Assignee: Electronics and Telecommunications Research Institute, Daejeon-city (KR)

(21) Appl. No.: 13/588,132

(22) Filed: Aug. 17, 2012

Related U.S. Application Data
(63) Continuation of application No. 12/096,415, filed on Jun. 6, 2008.

(30) Foreign Application Priority Data
Dec. 7, 2005 (KR) 10-2005-0119069
Aug. 30, 2006 (KR) 10-2006-0082932
Dec. 5, 2006 (KR) 10-2006-0122641

(51) Int. Cl. H04L 9/32; H04L 9/00

(52) U.S. Cl. 713/162; 713/176

(57) ABSTRACT

A mobile terminal provides a personal information sharing service using a signed URL message. The terminal includes; a personal information sharing service module which receives a message that includes a first callback URL and a personal information sharing request and is signed using a private key of a server, and creates a second callback URL by adding a user response result in response to the personal information sharing request to the first callback URL; and an authentication module which verifies a signature of the message using a public key of the server, and signs the second callback URL using a user private key.

### RELATED APPLICATIONS

This application is a continuation of U.S. application Ser. No. 12/096,415, filed on Jun. 6, 2008, which is a 35 U.S.C. 371 national stage filing of International Application No. PCT/KR2006/005296, filed Dec. 7, 2006 which claims priority to Korean Patent Application No. 10-2006-0122641 filed on Dec. 5, 2006, Korean Patent Application No. 10-2006-0082932 filed on Aug. 30, 2006, and Korean Patent Application No. 10-2005-0119069 filed on Dec. 7, 2005. The contents of the aforementioned applications are hereby incorporated by reference.

### BACKGROUND

The present invention relates to the providing of a personal information sharing service in a mobile terminal environment, and more particularly, to an apparatus and method for providing a service that securely and easily shares personal information using a signed callback uniform resource locator (URL) message in a mobile terminal environment.

These days, mobile terminal users increasingly use wireless Internet in various ways. However, mobile terminals using wireless Internet require more complex processes than a fixed terminal such as a PC. Also, mobile terminal users are not informed of the uniform resource locator (URL) of a web page that they view.

To address this problem, the URL of the web page is provided through a short message service (SMS) or a multimedia message service (MMS) to mobile terminal users, which is referred to as a callback URL. Mobile terminal users can easily use wireless Internet by pressing a “confirm” button or a “log on” button of a message including the callback URL to move the corresponding web page.

Korean Patent Application No. 10-2003-0086667 (Publication No.: 10-2005-0053067; Publication Date: 8 Jun. 2005) discloses a URL transmission method using a message. However, hackers can send mobile terminal users a message including a callback URL of a server in which malicious code is installed using the fact that mobile terminal users are not informed of the URL of the web page that they view.

Korean Patent Application No. 10-2003-0057219 (Publication No.: 10-2005-0019438; Publication Date: 8 Mar. 2005) discloses an electronic commerce system and method using a callback URL. Mobile terminal users use the callback URL in the electronic commerce system to move to a web page for purchasing goods. However, the callback URL does not include a signature, which causes a security problem.

Korean Patent Application No. 10-2002-0071762 (Publication No.: 10-2003-0007278; Publication Date: 23 Jan. 2003) discloses an instant log-in user authentication and payment method using heterogeneous communication networks. However, the method is limited to authenticating users, and a user identification code for identifying a sender needs to be identified in person by the users. A SMS including the callback URL has a problem in that security is not considered in the callback URL itself.

Korean Patent Application No. 10-2003-0072210 (Publication No.: 10-2005-0036512; Publication Date: 20 Apr. 2005) discloses an electronic payment approval method and system using an SMS including a callback URL. The callback URL is used to easily move users to a payment account operation server. Users write important information such as an authentication code after moving to a URL of the payment account operation server. Therefore, a sender cannot be identified through the SMS including the callback URL that does not include a signature, which causes a security problem.

Korean Patent Application No. 10-2004-0060025 (Publication No.: 10-2004-0101950; Publication Date: 3 Dec. 2004) discloses a wired/wireless unification authentication and payment method using an SMS and a mobile terminal storing authentication information. The method transmits the SMS for the authentication and/or payment including a callback URL to the mobile terminal. The SMS includes payment information and is used to confirm payment information and/or authentication via a user's input. However, the payment information and/or authentication can be confirmed only via the user's input.

### SUMMARY

The present invention provides an apparatus and method for producing a signed callback uniform resource locator (URL) in a message between a user and a server in a mobile terminal environment and ensuring security between a sender and a receiver.

The present invention provides an apparatus and method for managing a user's personal information via interaction between a server and a user anywhere and anytime by supporting a request to use the user's personal information in a mobile terminal environment.

According to an aspect of the present invention, there is provided a mobile terminal providing a personal information sharing service using a signed callback uniform resource locator (URL) message, comprising; a personal information sharing service module receiving a message that includes a first callback URL and a personal information sharing request and is signed using a private key of a server, and creating a second callback URL by adding a user response result in response to the personal information sharing request to the first callback URL; and an authentication module verifying a signature of the message using a public key of the server, and signing the second callback URL using a user private key.

According to another aspect of the present invention, there is provided a method of providing a personal information sharing service using a signed callback URL message in a mobile terminal, the method comprising: if a message that includes a first callback URL and a personal information sharing request and is signed using a private key of a server is received, verifying a signature of the message using a public key of the server; creating a second callback URL by adding a user response result in response to the personal information sharing request to the first callback URL; and signing the second callback URL using a user private key.

According to another aspect of the present invention, there is provided a server providing a personal information sharing service using a signed callback URL message, comprising; a personal information request service module creating a message that includes a first callback URL and a personal information sharing request, transmitting a message that is signed using a private key of a server to a user's mobile terminal, receiving a second callback URL—signed using a user private key—creased by adding a user response result in response to the personal information sharing request to the first callback URL, and providing a sharing service of personal information approved by a user; an authentication module signing the message using the private key of the server and verifying a signature of the message using a user public key; and a personal information storage module storing personal information of the user of the mobile terminal.

According to another aspect of the present invention, there is provided a method of providing a personal information sharing service using a signed callback URL message in a server, the method comprising: creating a message that includes a first callback URL and a personal information sharing request, signing the message using a private key of the server, and transmitting the message to a user's mobile terminal; if the user's mobile terminal accesses the server through a second callback URL obtained by adding a user response result in response to the personal information sharing request to the first callback URL, verifying a signature of the second callback URL signed using a user private key using a user public key; and providing a sharing service of personal information that the user approves to share according to the user's response result in response to the personal information sharing request.

According to another aspect of the present invention, there is provided a method of providing a personal information sharing service using a signed callback URL message in a mobile terminal, the method comprising: if a message that includes a first callback URL and summarized information relating to personal information sharing is received, accessing a server through the first callback URL; receiving details relating to the personal information sharing and a signature of the server from the server and verifying the signature using a public key of the server; adding a user response result in response to the details relating to the personal information sharing to the first callback URL and creating a second callback URL; and signing the second callback URL using a user private key.

According to another aspect of the present invention, there is provided a method of providing a personal information sharing service using a signed callback URL message in a server, the method comprising: creating a message that includes a first callback URL and summarized information relating to personal information sharing, and transmitting the message to a user's mobile terminal; if the user's mobile terminal accesses the server through the first callback URL, transmitting details relating to the personal information sharing and a signature obtained by signing the details using a private key of the server to the user's mobile terminal; if the user's mobile terminal accesses the server through a second callback URL obtained by adding a user response result in response to the details relating to the personal information sharing, verifying a signature of the second callback URL signed using a user private key using a user public key; and providing a sharing service of personal information that the user approves to share according to the user's response result in response to the details relating to the personal information sharing.

According to the present invention, when the use of user personal information is approved in a mobile terminal environment, a signed callback URL is used to verify a signature, identify a server and a user, and prevent a message from being forged.

According to the present invention, a mobile terminal is used to request approval to use user personal information, thereby providing the user with a real-time service customized to the user according to a user's response.

### BRIEF DESCRIPTION OF THE DRAWINGS

The above and other features and advantages of the present invention will become more apparent by describing in detail embodiments thereof with reference to the attached drawings in which:

FIG. 1 is a block diagram of a mobile terminal and a server according to an embodiment of the present invention;

FIG. 2 is a schematic flowchart illustrating a method of providing a personal information sharing service in the mobile terminal and the server illustrated in FIG. 1;

FIG. 3 is a flowchart illustrating a method of creating a personal information sharing request message and transferring the message in the server illustrated in FIG. 1;

FIG. 4 is a flowchart illustrating a method of receiving a message and processing the message in the mobile terminal illustrated in FIG. 1;

FIG. 5 is a flowchart illustrating a method of receiving a response through a callback URL and processing the response in the server illustrated in FIG. 1;

FIG. 6 is a diagram of a message received from the mobile terminal illustrated in FIG. 1; and

FIG. 7 is a schematic flowchart illustrating a method of providing a personal information sharing service in the mobile terminal and the server illustrated in FIG. 1 according to another embodiment of the present invention.

### DETAILED DESCRIPTION OF EMBODIMENTS

The present invention will now be described more fully with reference to the accompanying drawings, in which embodiments of the present invention are shown.

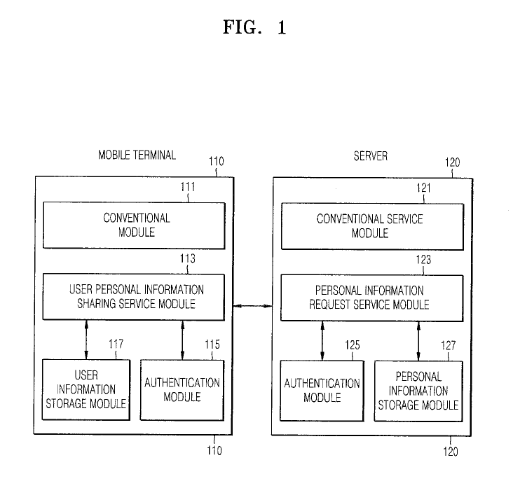

FIG. 1 is a block diagram of a mobile terminal 110 and a server 120 according to an embodiment of the present invention. Referring to FIG. 1, the mobile terminal 110 comprises a user personal information sharing service module 113, an authentication module 115, and a user information storage module 117 in addition to a conventional module 111.

The user personal information sharing service module 113 receives a message including a first callback uniform resource locator (URL) and a personal information sharing request the message signed with a private key of the server 120, and produces a 2^{nd} callback URL by adding a user's result in response to the personal information sharing request to 1st callback URL.

In more detail, the user personal information sharing service module 113 receives a short message service (SMS) or multimedia message service (MMS) message including the signed first callback URL. The user personal information sharing service module 113 determines whether to share personal information particulars included in the message. The received message includes a signature obtained by signing the message and the first callback URL using the private key of the server 120 in the authentication module 125 of the server 120. The message including the signature is received to secure integrity of the message and callback URL.

The message may include an image of the person or institution that requests to share user personal information, in order to easily identify the person or institution. If so, the mobile terminal 110 needs to display the image.

The user personal information sharing service module 113 transfers the message to the authentication module 115 to verify the signature of the message.

If the signature is verified, the user personal information sharing service module 113 receives a user's response to the request to share the user personal information. The decision of whether to share the user personal information is made automatically according to rules defined by the user, or is input by the user after the user reads the personal information particulars. The user's response is to allow or deny, but can provide other information.

The user may write his/her personal information through the mobile terminal 110 or may use personal information that has been stored in the user information storage module 117 included in the mobile terminal 110.

If the user personal information sharing service module 113 receives a result in response to the received message from the user, the user personal information sharing service module 113 adds the user's response result to the first callback URL to produce the second callback URL. The second callback URL includes information on the server 120 designated by the first callback URL. Therefore, the mobile terminal 110 accesses the server 120 through the second callback URL and simultaneously transmits the user's response result to the server 120.

The user's response result may be added to the first callback URL as a parameter, in the form of plain text, a signed string, or a cipher text.

The authentication module 115 performs a signature and verification operation using the user's private key and public keys of reliable servers. Key information needs to be stored in a secure location.

The user's private key and public keys used by the authentication module 115 may be stored in a separate device that may or may not be attached to the mobile terminal 110. The user's private key and public keys can be stored in a device separate from the mobile terminal 110. The device can be attached to the mobile terminal 110 as occasion demands, to use the key information through the authentication module 115.

When the message received by the user personal information sharing service module 113 is transferred to the authentication module 115, the authentication module 115 loads a public key of the server 120 to verify whether the signature of the message is valid.

When user personal information sharing service module 113 transfers the second callback URL to the authentication module 115, the authentication module 115 loads the user's private key and signs the second callback URL with the key. That is, the authentication module 115 signs the second callback URL to add the signature to the second callback URL as a parameter.

The user information storage module 117 stores the user personal information and a personal information sharing policy, and automatically performs a user's response to the request to share the user personal information using the user personal information and the personal information sharing policy.

The user information storage module 117 can be stored in equipment other than the mobile terminal 110, and can be attached to the mobile terminal 110 as occasion demands, to be used through the user personal information sharing service module 113.

When the user information storage module 117 is used, a response of the user personal information sharing service module 113 can include personal information corresponding to sharing request particulars. In this regard, a personal information request service module 123 included in the server 120 receives the personal information to use them.

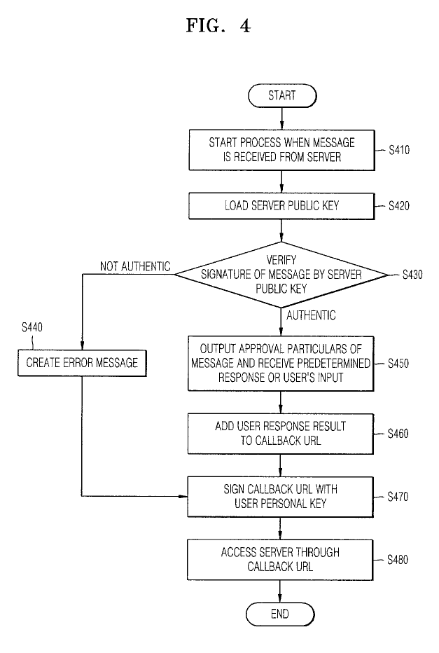

A method of providing a personal information sharing service using a signed callback URL message in the mobile terminal 110 will be described in detail with reference to FIG. 4. The server 120 of the current embodiment of the present invention includes a personal information request service module 123, an authentication module 125, and a personal information storage module 127 in addition to a conventional service module 121.

The personal information request service module 123 produces a message including a first callback URL and a personal information sharing request, and transmits the message (signed using a private key of the server 120) to the user's mobile terminal 110. The personal information request service module 123 receives a second callback URL and provides the personal information sharing service approved by the user. The mobile terminal 110 adds a user response result to the personal information sharing request to the first callback URL to be signed using a user's private key, which is referred to as the second callback URL.

In more detail, the personal information request service module 123 produces an SMS or MMS to request the user to share personal information particulars, and receives a response from the user. When the conventional service module 121 or another service process needs the user's personal information, the personal information particulars are transferred to the personal information request service module 123. The personal information request service module 123 downloads user information and prepares a message using a user's mobile terminal number. The message includes the personal information particulars requested to be shared to the user and the first callback URL to receive a response of the message. The first callback URL is signed using the private key of the server 120 so that a message receiving side verifies the signature of the message to determine whether the message is transmitted from an authentic server.

The message to be transmitted to the mobile terminal 110 may include an image of the person or logo institution that requests to share user personal information, in order to easily identify the person or institution.

When the personal information request service module 123 receives a response result to the transmitted message from the mobile terminal 110, the personal information request service module 123 transfers the response result to the authentication module 125 to verify the second callback URL. After completely verifying the second callback URL, the personal information request service module 123 compares the response result included in the second callback URL with the personal information particulars to determine whether to provide the personal information sharing service.

The authentication module 125 performs a signature and authentication operation using the private key of the server 120 and users' public keys. Key information is located in a secure location to be utilized through the authentication module 125.

When the personal information request service module 123 transfers a message to be transmitted to the mobile terminal 110 to the authentication module 125, the authentication module 125 loads the private key of the server 120, signs the message and a first callback URL included in the message, and adds a signature to the first callback URL as a parameter.

When the personal information request service module 123 transfers a response received from the mobile terminal 110 to the authentication module 125, the authentication module 125 loads a user's public key to verify whether a signature included in a second callback URL is valid.

The personal information storage module 127 stores the user's personal information in a secure location of the server 120.

The personal information storage module 127 may be stored in a location other than the server 120, and can be interlocked with the server 120 as occasion demands, to be used through the personal information request service module 123. If users are approved to share the personal information particulars requested by the server 120 in response to the user of callback URLs, the user personal information sharing service module 113 of the mobile terminal 110 requests the personal information storage module 127 to use the personal information.

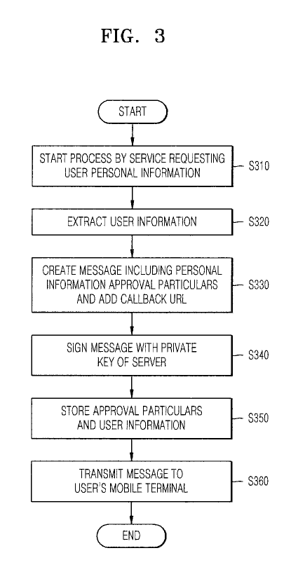

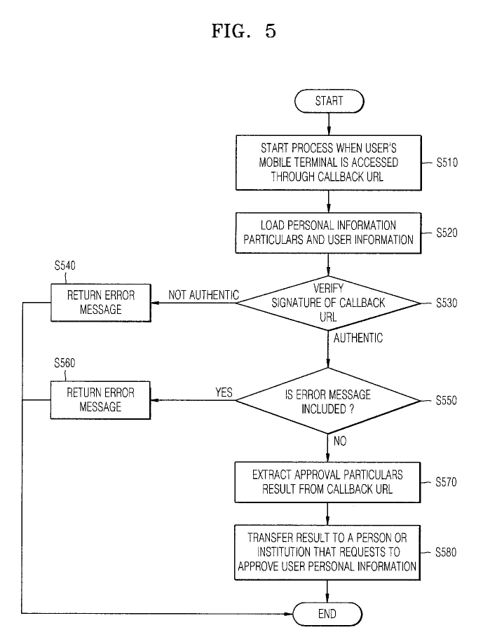

A method of providing a personal information sharing service using a signed callback URL message in a server will be described in detail with reference to FIGS. 3 and 5.

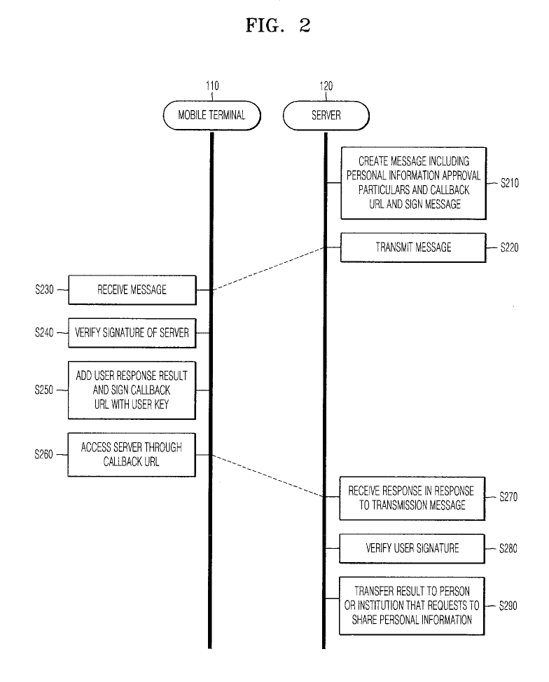

FIG. 2 is a schematic flowchart illustrating a method of providing a personal information sharing service in the mobile terminal and the server illustrated in FIG. 1. Referring to FIG. 2, the mobile terminal 110 and the server 120 communicate a message and a response to provide the personal information sharing service.

The server 120 prepares a message including personal information approval particulars and a callback URL, and signs the message using a private key of the server 120 (Operation 210). The server 120 transmits the message to the mobile terminal 110 (Operation 220).

The mobile terminal 110 receives the message (Operation 230), and verifies the signature of the message using a public key of the server 120 (Operation 240). If the signature is verified, the mobile terminal 110 adds the user's response result to a personal information approval request to the callback URL, signs the callback URL using the user's private key (Operation 250), and transmits the message to the server 120 through the signed callback URL (Operation 260).

If the mobile terminal 110 accesses the server 120 through the callback URL, the server 120 receives a response to the transmitted message via information attached to the callback URL as a parameter (Operation 270). The server 120 verifies the signature of the callback URL using the user's public key (Operation 280). If the signature is verified, the server 120 transfers personal information that the user approves to share, to the personal information sharing service.

FIG. 3 is a flowchart illustrating a method of creating a personal information sharing request message and transferring the message in the server 120 illustrated in FIG. 1. Referring to FIG. 3, the process starts by a service requesting the server 120 for user personal information (Operation 310). The server 120 loads information including a number or address of a user's mobile terminal and a personal information value established by the user (Operation 320).

The server 120 creates a message including personal information particulars to request the user to share (Operation 330). At this time, the server 120 establishes a callback URL so that the user can easily make a response. The server 120 adds information on the user, and an image of the person or a logo institution that requests to share the personal information, to the message so that the user can easily identify the person or institution. The image or logo is important material for the decision of whether to share the personal information.

The authentication module 125 of the server 120 signs the message including the callback URL using a private key of the server 120 (Operation 340).

After the message is completely created, the server 120 stores the personal information particulars and other information in a temporary storage (Operation 350). The personal information particulars and other information are used when the user responds to the callback URL. The server 120 transmits the message to the number or address of the user's mobile terminal (Operation 360).

FIG. 4 is a flowchart illustrating a method of receiving a message and processing the message in the mobile terminal 110 illustrated in FIG. 1. Referring to FIG. 4, the process starts when the mobile terminal 110 receives a message including a user personal information sharing request from a server (Operation 410). The authentication module 115 of the mobile terminal 110 loads a server public key (Operation 420), and verifies a signature included in the message (Operation 430).

As a result of verifying the signature of the mobile terminal 110, if it is determined that the signature is not authentic, the mobile terminal 110 creates an error message to prevent user personal information from being shared, and returns the error message (Operation 440).

If it is determined that the signature is authentic, the mobile terminal 110 displays user personal information particulars specified in the message and content on whether to share the user personal information, to receive a response from a user (Operation 450).

The user may identify the person or institution that requests to share his/her personal information using an image included in the message.

The response to the personal information sharing request may be created by the user or may be automatically created according to rules provided by the user. For example, if the user establishes to share his/her ID number with a bank site, when the bank site requests the user's ID number, a share approval response is automatically provided to the bank site without a response from the user.

The user's response is to allow or deny, but can provide other information. Information of the user information storage module 117 illustrated in FIG. 1 of the mobile terminal 110 may be used, or the user may input information in person using the mobile terminal 110.

The mobile terminal 110 adds the user's response result to a callback URL included in the message (Operation 460). If an error occurs during the verification of a signature of the server, the mobile terminal 110 adds the content of the error message to the callback URL instead of the user's response result.

The authentication module 115 of the mobile terminal 110 loads a user's private key, signs the whole callback URL, and adds the signature to the callback URL (Operation 470).

A variety of information may be added to the callback URL as parameters, in the form of plain text, a signed string, or a cipher text.

The mobile terminal accesses a server through the signed callback URL (Operation 480) so that the user's response result to the personal information sharing request can be securely transferred to the server.

FIG. 5 is a flowchart illustrating a method of receiving a response through a callback URL and processing the response in the server 120 illustrated in FIG. 1. Referring to FIG. 5, the process starts when a user's response result to a personal information sharing request is transferred to a server, i.e. a user's mobile terminal accesses the server through a callback URL (Operation 510).

If the mobile terminal accesses the server 120, the server 120 loads the user personal information particulars and other information (refer to Operation 350 illustrated in FIG. 3) (Operation 520).

The authentication module 115 of the server 120 verifies a signature made by the user's private key attached to the callback URL using the user's public key (Operation 530) in order to determine whether the signature of the callback URL is authentic, using the user's public key stored in the server 120.

If it is determined that the signature of the callback URL is authentic, the server 120 returns an error message and terminates a service (Operation 540). The server 120 determines whether the verified callback URL includes the error message (Operation 550), if it is determined that the verified callback URL includes the error message, and the server 120 returns the error message and terminates the service (Operation 560).

If the user's response result is properly included in the callback URL, the server 120 extracts the user's response result and compares the user's response result with the loaded user personal information particulars.

The server 120 transfers user personal information that the user approves to share to the service (Operation 580). The server 120 can request the approved user personal information from the personal information storage module 127 illustrated in FIG. 1. If the user specifies the personal information in person, the specified personal information is transferred to the service.

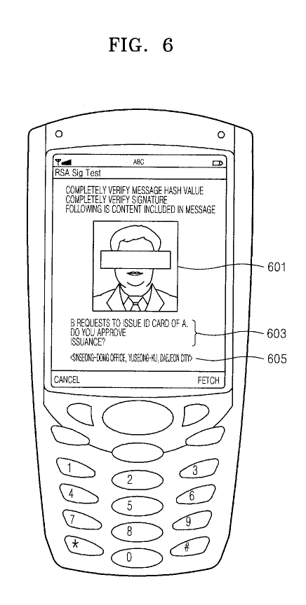

FIG. 6 is a diagram of a message received from the mobile terminal 110 illustrated in FIG. 1. Referring to FIG. 6, the mobile terminal 110 displays an image 601 of the person or an institution that requests to share user personal information, lists of the personal information 603 that is requested to be shared, and a subject 605 that sends a message. The user confirms the person or institution that requests his/her personal information through the image 601.

The integrity of a personal information sharing request through a signature verification process is secure since content of the personal information sharing request is included in a message signed using a private key of a server.

The subject 605 that sends the message uses a name specified in a certificate that has authorized information, so that the reliability of the certificate can be improved. Therefore, when a server that transmits a message through a signed callback URL included in the message is accessed, and a personal information sharing service is provided, security is maintained.

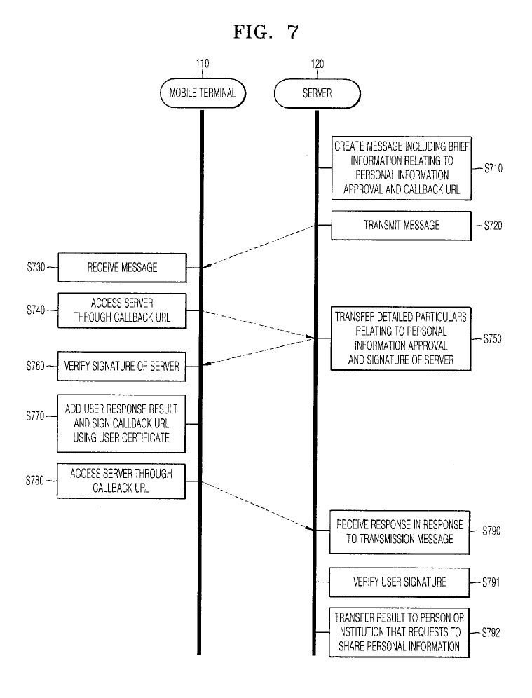

FIG. 7 is a schematic flowchart illustrating a method of providing a personal information sharing service in the mobile terminal and the server illustrated in FIG. 1 according to another embodiment of the present invention. Referring to FIG. 7, the mobile terminal 110 and the server 120 communicate a message and a response to provide the personal information sharing service in the same manner as illustrated in FIG. 2.

The method of providing the personal information sharing service of the present embodiment, which does not transmit personal information approval particulars and a signature of a callback URL at an initial access to the server 120 but transmits summarized information of the personal information approval particulars and receives a response via the summarized information, is different from the method described with reference to FIG. 2. Therefore, the present invention can be applied to a message transmission environment where a limited amount of information is transmitted at the initial access to the server 120. It will be understood by those of ordinary skill in the art that the details of each operation described with reference to FIGS. 2 through 5 can be applied to operations that are to be described with reference to FIG. 7.

The server 120 prepares a message including personal information approval particulars and a first callback URL (Operation 710). The personal information approval particulars include summarized information and may not be signed. The server 120 transmits the message to the mobile terminal 110 (Operation 720).

The mobile terminal 110 receives the message (Operation 730), and accesses the server 120 through the first callback URL in order to obtain details of the personal information approval particulars and a signature of the server 120 (Operation 740). If the server 120 transfers details relating to the personal information approval and a signature obtained by signing the details using a private key of the server 120 (Operation 750), the mobile terminal 110 verifies a signature of the message using a public key of the server 120 (Operation 760). If the signature is verified, the mobile terminal 110 adds a user's response result to the details relating to the personal information approval to the first callback URL so as to create a second callback URL, signs the second callback URL using a user's private key (Operation 770), and accesses the server 120 that transmitted the message through the signed second callback URL (Operation 780).

If the mobile terminal 110 accesses the server 120 through the second callback URL, the server 120 receives a response to the transmitted message via information attached to the second callback URL as a parameter (Operation 790). The server 120 verifies the signature of the second callback URL using a user's public key (Operation 791). If the signature is verified, the server 120 transfers personal information that the user approves to share, to the personal information sharing service (Operation 792).

The present invention can also be embodied as computer readable code on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves. The computer readable recording medium can also be distributed network coupled computer systems so that the computer readable code is stored and executed in a distributed fashion.

While the present invention has been particularly shown and described with reference to exemplary embodiments thereof, it will be understood by those of ordinary skill in the art that various changes in form and detail may be made therein without departing from the spirit and scope of the present invention as defined by the following claims.

1. A method for transmitting a message in a server, comprising:
generating a first callback URL to be transmitted to a terminal;
generating request information to be transmitted to the terminal;
generating a message by encrypting the request information; and
transmitting the first callback URL and the message to the terminal.

2. The method of claim 1, wherein the request information is encrypted using a private key of the server.

3. A method for transmitting a message to a server, comprising:
generating a first callback URL to be transmitted to a terminal;
generating request information to be transmitted to the terminal;
generate a message by encrypting the request information and the first callback URL; and
transmitting the message to the terminal.

4. The method of claim 3, wherein the request information and the first callback URL is encrypted using a private key of the server.

5. A method for receiving a message in terminal, comprising:
receiving the request message that includes a first callback URL and request information that is signed using a encryption key of a server from the server;
loading a pre-stored decryption key of the server; and
verifying a signature of the request message using the loaded decryption key of the server.

6. The method of claim 5, wherein the encryption key of the server is a private key of the server and the decryption key of the server is a public key of the server.

7. The method of claim 5, wherein further comprising: if the signature of the request message is authentic, accessing the server through the first callback URL.

8. The method of claim 7, wherein further comprising:
generating a response in response to the request message;
generating a second callback URL to be transmitted to a server;
encrypting the response and generating a response message by combining the encrypted response and the second callback URL; and
transmitting the response message to the server.

9. The method of claim 8, wherein the response is encrypted using a private key of the terminal.

10. The method of claim 8, wherein the server decrypts the response message and processing the response message when the response message is authentic.

11. The method of claim 10, wherein the response is decrypted using a public key of the terminal.

12. A method for receiving a message in terminal, comprising:
receiving the request message that includes a first callback URL and request information and is signed using a encryption key of a server from the server;
loading a pre-stored decryption key of the server; and
verifying a signature of the request message using the loaded decryption key of the server.

13. The method of claim 12, wherein the encryption key of the server is a private key of the server and the decryption key of the server is a public key of the server.

14. The method of claim 12, wherein further comprising: if the signature of the request message is authentic, accessing the server through the first callback URL.

15. The method of claim 12, wherein further comprising:
generating a response in response to the request information;
generating a second callback URL to be transmitted to a server;
encrypting the response and generating a response message by combining the encrypted response and the second callback URL; and
transmitting the response message to the server.

16. The method of claim 15, wherein the response is encrypted using a private key of the terminal.

17. The method of claim 15, wherein the server decrypts the response message and processing the response message when the response message is authentic.

18. The method of claim 17, wherein the response is decrypted using a public key of the terminal.

19. A method for a message transmission between a server and a terminal, comprising:
encrypting request information using a first encryption key in a server;
transmitting the request message including the encrypted requested information and a first callback URL to the terminal;
decrypting the requested information in the request message using a first decryption key in the terminal;
accessing the server through the first callback URL in the terminal;
generating a response information in response to the request information in the terminal;
encrypting the response information using a second encryption key in the terminal;
transmitting the encrypted response information to the server; and
decrypting the response information using a second decryption key in the server.
